(19) United States
(12) Patent Application Publication
(10) Pub. No.: US 2012/0254607 A1
(43) Pub. Date: Oct. 4, 2012

(54) System And Method For Security Levels With Cluster Communications

(75) Inventors: Jes Kiran Chittigala, Hyderabad (IN); Ravi A. Shankar, Austin, TX (US); Ranganathan Vidya, Bangalore (IN)

(73) Assignee: International Business Machines Corporation, Armonk, NY (US)

(21) Appl. No.: 13/078,579

(22) Filed: Apr. 1, 2011

(51) Int. Cl. H04L 9/00

(52) U.S. Cl. 713/150

(57) ABSTRACT

A cluster of computing nodes communicate through an unsecure network by selectively sending information in encrypted and unencrypted formats. Heartbeat packets are sent between the computing nodes to coordinate operation of the computing nodes and using an encrypted format. Messages are selectively sent between the computing nodes with an encrypted or an unencrypted format based upon one or more predetermined factors, such as an end user selection, the type of message or the load at the computing nodes.

### BACKGROUND OF THE INVENTION

1. Field of the Invention

The present invention relates in general to the field of cluster node computing, and more particularly to a system and method for security levels with cluster communications.

2. Description of the Related Art

Computer systems are sometimes interconnected in loosely coupled nodes to form a “cluster.” High availability clusters provide load sharing, redundancy and more effective performance. A cluster has at least two nodes which cooperate to ensure high availability of services by sharing responsibility for executing applications. If an application on a particular node fails, a high availability cluster automatically detects the fault at a node and restarts the application on another node in a process known as Failover. High availability clusters are an attractive solution for critical databases, file sharing on a network, business applications and customer services, such as e-commerce websites.

In order to provide high availability, cluster nodes communicate to each other regarding liveliness of nodes, critical message exchange and event details. In this manner clustering software executing on the nodes supports “failover” by configuring nodes to before applications start, such as by sharing appropriate file systems and hardware configurations and by having certain applications standing by. Typically, clusters use a “heartbeat” and private connection to monitor the health and status of each node in the cluster. Each node runs a heartbeat daemon and exchanges messages called heartbeats to inform other nodes of its state. In the event of a failure, the heartbeat daemon on a back-up node initiates applications for failover.

If cluster nodes do not interconnect through a secure hardwired interface, cluster security typically calls for encryption/signing of all packets sent between nodes, including heartbeat packets, critical messages and other non-critical messages of more ordinary priority. A difficulty with the use of encryption is that encryption introduces performance delays that can impact cluster operations.

### SUMMARY OF THE INVENTION

Therefore, a need has arisen for a system and method which selectively encrypts cluster node communications.

In accordance with the present invention, a system and method are provided which substantially reduce the disadvantages and problems associated with previous methods and systems for encrypting cluster node communications. Computing nodes of a cluster selectively communicate some but not all information between each other in an encrypted format based upon one or more predetermined condition that balance cluster security with cluster performance.

More specifically, plural computing nodes communicate heartbeat packets and messages to form a cluster. A security module executing on one or more of the computing nodes selectively communicates predetermined of the information between the nodes in encrypted and unencrypted formats based upon predetermined conditions. For example, heartbeat packets between the computing nodes are always sent in an encrypted format while other messages are selectively sent in unencrypted formats. Messages may be defined as critical and non-critical with critical messages encrypted and non-critical messages unencrypted. Alternatively, messages are selectively sent in an unencrypted format based upon a workload at one or more of the computing nodes, a time period, the type of message, a manual selection by an end user or other predetermined conditions.

The present invention provides a number of important technical advantages. One example of an important technical advantage is that cluster nodes communicate with selectively-set security levels to provide improved cluster performance Selectively setting cluster security levels balances performance and security concerns based upon user requirements. A low security setting that encrypts only heartbeat packets decreases processing delays for communicating critical and non-critical messages so that delays in cluster operations are minimized where the security criticality of an end user's environment allows. A high security setting accepts the risk of performance delays to provide encryption of all messages to help prevent malicious interference with cluster operations. Intermediate security settings allow end user's to balance security and performance risks based upon the type of information in messages and conditions within the cluster environment, such as the processing load at cluster nodes.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a cluster of computing nodes that selectively communicate using encrypted and unencrypted information;

FIG. 2 depicts a block diagram of functional software elements that support selective communication of encrypted and unencrypted information between computing nodes of a cluster; and

FIG. 3 depicts a flow diagram of a process of selective communication between computing nodes of a cluster in encrypted or unencrypted formats.

### DETAILED DESCRIPTION

A system and method provides communication between computing nodes of a cluster that balances security of the cluster with performance of the cluster by selectively sending the communications in encrypted and unencrypted formats.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

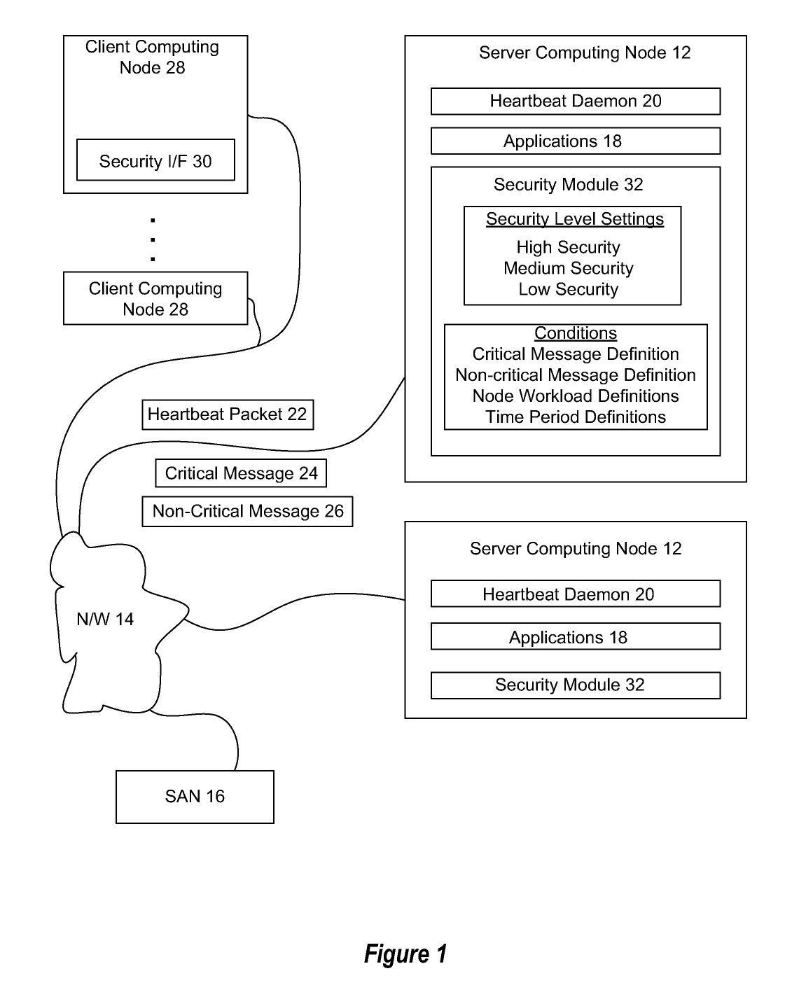

Referring now to FIG. 1, a block diagram depicts a cluster 10 of computing nodes 12 that selectively communicate using encrypted and unencrypted information. Computing nodes 12 communicate through a network 14, such as the Internet, and interface with storage devices, such as a storage area network 16. Computing nodes 12 provide failover so that applications 18 executing on one or more of computing nodes 12 will recover to another computing node 12 in the event of a hardware or software failure. In order to provide failover functionality, computing nodes 12 each include a heartbeat 20, which communicate heartbeat packets 22 between each other. Heartbeat packets as used herein means the heartbeat packets used by conventional clusters, such as High Availability Cluster Multi-Processing for AIX (HACMP) applications available from IBM Corporation or similar clustering applications. In addition to heartbeat packets, applications 18 executing on computing nodes 12 send critical messages 22 and non-critical messages 24 to each other.

In the event that network 14 is not a secure network, heartbeat packets 22, critical messages 24 and non-critical messages 26 are all typically communicated with encryption/signing in an encrypted format to prevent interference with operations of cluster 10 by unauthorized or malicious users. However, sending heartbeat packets plus all messages in the encrypted format can lead to performance delays that impact the performance of cluster 10 due to extra steps used for encryption and decryption of the heartbeat packets and messages. In order to balance performance and security within a cluster 10, a client node 28 supports a security interface 30 that allows an end user to adjust security levels used by a security module 32 to communicate information within the cluster 10. Security module 32 allows an end user to set a high security level in which all heartbeat packets and messages are sent in the encrypted format, a medium security level in which all heartbeat packets and critical messages are sent in the encrypted format while non-critical messages are sent in an unencrypted format, and a low security level in which heartbeat packets are sent in the encrypted format while critical and non-critical messages are sent in the unencrypted format. The end user can manually set the security level or can have security module 32 implement the security level based upon predetermined conditions. For example, a security level is automatically implemented based upon the load at one or more of the computing nodes 12, such as to maintain a performance level at the computing nodes 12 by reducing the resources needed for encryption when performance of a computing node 12 falls to a predetermined load. The amount of resources needed for encryption in level 2 may be adjusted by setting definitions for critical versus non-critical messages, such as based upon the type of application associated with the message.

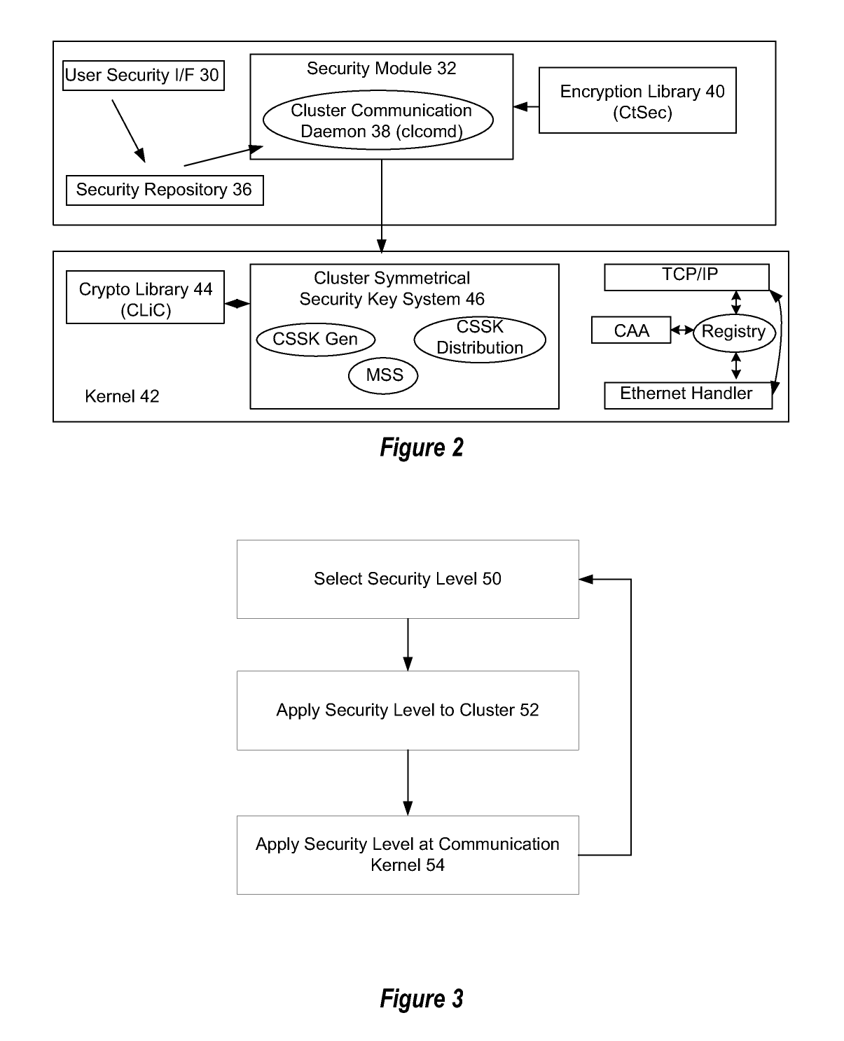

Referring now to FIG. 2, a block diagram depicts functional software elements that support selective communication of encrypted and unencrypted information between computing nodes of a cluster. User interface 30 provides access to security module 32 to allow end user inputs for selection of a cluster security level.

The selected security level is stored in a cluster repository 36, and storage of a security level in cluster repository 36 automatically refreshes the cluster communication daemon 38 to implement the security level. In one embodiment, cluster repository 36 includes logic that detects predetermined conditions and implements a security level associated with the predetermined conditions upon detection, such as implementation of a lower security level if greater than a predetermined load is executing at a computing node of a cluster. Cluster communication daemon 38 reads the cluster security configuration level from security repository 36 and uses an encryption library 40 to apply the selected security level. A kernel extension 42 is informed of the level of security that is applied and uses a crypto library to provide encryption at the kernel so that a cluster symmetric secret key 46 is applied to communications sent through TCP/IP and Ethernet layers 48.

Referring now to FIG. 3, a flow diagram depicts a process of selective communication between computing nodes of a cluster in encrypted or unencrypted formats. The process begins at step 50 with selection of a cluster security level for implementation at a cluster, such as with a manual selection by an end user or with the meeting of predetermined conditions in the cluster environment. At step 52, a cluster communication daemon reads the cluster security level and uses an encryption library to establish the security level at the cluster computing nodes. At step 54, a kernel extension used to communication between computing nodes of a cluster is informed of the security level and coordinates encryption of messages based upon the security level. The security level remains set until a new security level is established at step 50.

Although the present invention has been described in detail, it should be understood that various changes, substitutions and alterations can be made hereto without departing from the spirit and scope of the invention as defined by the appended claims.

What is claimed is:

1. A method for interfacing nodes of a cluster, the method comprising:
sending predetermined information between the nodes in an encrypted format;
selectively engaging a predetermined security level; and
in response to the selectively engaging, sending some but less than all of the predetermined information in the encrypted format.

2. The method of claim 1 wherein the predetermined information comprises a heartbeat packet and messages.

3. The method of claim 2 wherein the in response to the selectively engaging further comprises sending the heartbeat packet encrypted and sending the messages unencrypted.

4. The method of claim 2 wherein the in response to the selectively engaging further comprises sending the heartbeat packet encrypted and sending some but less than all of the messages encrypted.

5. The method of claim 4 wherein critical messages are encrypted and non-critical messages are unencrypted.

6. The method of claim 1 wherein the sending predetermined information further comprises sending the predetermined information through an unsecure network interface.

7. The method of claim 1 wherein selectively engaging a predetermined security level further comprises:
analyzing a load of a node; and
automatically engaging the predetermined security level if the load exceeds a predetermined load.

8. The method of claim 1 wherein selectively engaging a predetermined security level further comprises:
analyzing an application associated with the messages; and
automatically engaging the predetermined security level if the application is a predetermined application.

9. A cluster computing system comprising:
first and second computing nodes interfaced through a network;
a heartbeat executing on each of the first and second computing nodes and operable to communicate heartbeat packets between the first and second computing nodes, the heartbeat packets providing information to coordinate operation of the first and second nodes;
one or more applications executing on each of the first and second computing nodes and operable to communicate messages between the first and second nodes; and
a security module executing on at least one of the first and second computing nodes and operable to selectively send the heartbeat packets and messages encrypted at a first security level and to send the heartbeat packets and messages with some but not all encrypted at a second security level.

10. The cluster computing system of claim 9 further comprising a third security level having the heartbeat packets encrypted, at least some messages encrypted and at least some messages unencrypted.

11. The cluster computing system of claim 10 further comprising a security interface executing on a client and operable to manually set the security level.

12. The cluster computing system of claim 9 wherein the security module is further operable to automatically select the first or second security level based on one or more predetermined conditions.

13. The cluster computing system of claim 12 wherein the predetermined condition comprises the type of application associated with the messages.

14. The cluster computing system of claim 12 wherein the predetermined condition comprises the load at the computing node on which the security module is executing.

15. The cluster computing system of claim 12 wherein the predetermined condition comprises the load at the computing node on which a security module is not executing.

16. The cluster computing system of claim 9 wherein the second security level encrypts all of the heartbeat packets and none of the messages.

17. A method for interfacing computing nodes of a cluster, the method comprising:
sending heartbeat packets between the computing nodes in an encrypted format; and
selectively sending messages between the computing nodes in an encrypted format and an unencrypted format based upon one or more predetermined conditions.

18. The method of claim 17 wherein the predetermined conditions comprise the type of messages.

19. The method of claim 17 wherein the predetermined conditions comprise the load at one or more of the computing nodes.

20. The method of claim 17 wherein the predetermined conditions comprise an end user selection.
